(19) United States
(12) Patent Application Publication
(10) Pub. No.: US 2023/0235533 A1
(43) Pub. Date: Jul. 27, 2023

(54) Remote Wireless Hydraulic Frame

(71) Applicants: ZOOMLION Heavy Industry NA, Inc., Yorkville, WI (US); ZOOMLION Heavy Industry Science and Technology Co., Ltd., Changsha Hunan Province (CN)

(72) Inventors: Mark McKinley, Wauwatosa, WI (US); Brittney Bembenek, Milwaukee, WI (US); Matthew Seeger, Franskville, WI (US)

(21) Appl. No.: 17/586,017

(22) Filed: Jan. 27, 2022

(51) Int. Cl. E02F 9/22; F15B 13/08; E02F 9/20

(52) U.S. Cl. CPC E02F 9/2267; E02F 9/2285; E02F 9/2228; F15B 13/0864; E02F 9/205

(57) ABSTRACT

A remote wireless hydraulic frame preferably includes a frame member, a frame transceiver, a frame bridge controller and an electro-hydraulic conversion valve. The frame bridge controller receives signals from a cab bridge controller through a cab transceiver and the frame transceiver. The frame member preferably includes a frame support, an engine, a hydraulic pump, at least one electrical component and a plurality of hydraulicly operated components. The electro-hydraulic conversion valve preferably includes a valve block and a plurality of proportioning valves. The plurality of proportioning valves receive a hydraulic electrical signal from a hydraulic control device located in a remote wireless hydraulic cab through the cab bridge controller. Hydraulic fluid is sent from the valve block to a plurality of hydraulic operated components on the frame support. Control electrical signals are also received from the cab bridge controller to operate at least one electrical component on the frame support.

### BACKGROUND OF THE INVENTION

### 1. Field of the Invention

The present invention relates generally to heavy equipment and more specifically to a remote wireless hydraulic frame, which is used in conjunction with a remote wireless hydraulic cab for remote operation of the remote wireless hydraulic frame by the remote wireless hydraulic cab.

### 2. Discussion of the Prior Art

The remote wireless hydraulic frame is located a distance from the remote wireless hydraulic cab. The remote wireless hydraulic frame includes at least one tool, such as a shovel. The remote wireless hydraulic cab communicates wirelessly with the remote wireless hydraulic frame. The wireless communication may be implemented with any suitable wireless protocol. The remote wireless hydraulic cab includes hydraulic operated joysticks and foot treadles, which must be supplied with hydraulic fluid to operate the at least one tool. The remote wireless hydraulic cab is supplied with electrical power through an electrical generator and pressurized hydraulic fluid through a hydraulic pump. The inputs from the hydraulic joysticks and foot treadles are converted into electrical signals and transmitted wirelessly to the remote wireless hydraulic frame.

The remote wireless hydraulic frame receives electrical signals from the remote wireless hydraulic cab and converts the wireless electrical signals for controlling a plurality of hydraulic valves. It appears that the prior art does not teach or suggest a system for remote wireless operation of at least one tool on a remote wireless hydraulic frame by a remote wireless hydraulic cab.

Accordingly, there is clearly felt need in the art for a remote wireless hydraulic frame, which is used in conjunction with a remote wireless hydraulic cab for remote operation of the remote wireless hydraulic frame and the at least one tool by the remote wireless hydraulic cab.

### SUMMARY OF THE INVENTION

The present invention provides a remote wireless hydraulic frame, which allows a remote wireless hydraulic cab to be detached and remotely operated from a heavy equipment frame. The remote wireless hydraulic cab preferably includes a cab member, an electrical bulkhead, a cab bridge controller and a cab transceiver. The cab member preferably includes a cab enclosure, a plurality of hydraulic joysticks, a plurality of hydraulic treadles, a plurality of hydraulic lines and a plurality of electrical control devices. One end the plurality of hydraulic lines are connected to the plurality of joysticks and the plurality of hydraulic treadles. Two of the plurality of hydraulic lines are a hydraulic pressure line and a hydraulic return line.

The hydraulic pressure line, the hydraulic return line and the plurality of hydraulic joysticks and hydraulic treadles are connected to a hydraulic circuit block. An opposing end of the plurality of hydraulic lines may be retained in a hydraulic sensor plate. A plurality of quick disconnect adapters extent from one side of the hydraulic sensor plate and a plurality of threaded adapters extend from an opposing side of the hydraulic sensor plate. The plurality of quick disconnect adapters are sized to receive the opposing end of the plurality of hydraulic lines. The plurality of hydraulic pressure sensors are threaded into plurality of threaded adapters. Hydraulic pressure in the plurality of hydraulic lines are measured by the plurality of hydraulic pressure sensors. An electrical output from each hydraulic pressure sensor is connected to the cab bridge controller. The electrical bulkhead includes a signal socket and a power socket. A signal cable includes a bulkhead plug extending from one end and a controller plug extending from an opposing end. The bulkhead plug is plugged into the signal socket and the controller plug is plugged into the cab bridge controller for transfer of electrical signals from the cab member to the cab bridge controller. A vehicle controller is preferably used to receive electrical signals from a button panel. The vehicle controller is also used to display information to an operator display. The vehicle controller is also connected to the cab bridge controller.

An output from the cab bridge controller is connected to the cab transceiver. The cab transceiver transmits the plurality of electrical signals from the plurality of hydraulic pressure sensors and electrical signals from the vehicle controller through the signal socket. A hydraulic pump is connected to the hydraulic pressure and return lines. A power cable includes a generator plug on one end and a power plug on an opposing end. The generator plug is connected to an electrical generator and the power plug is plugged into the power socket. With the hydraulic pump and the electric generator connections, the remote wireless hydraulic cab is capable of operating remotely from a remote wireless hydraulic frame through wireless communication.

A docking station may be used to provide a physical foundation and an operational base for the remote wireless hydraulic cab. The docking station includes a base member, a hydraulic pump and an electrical generator. The base member includes a support base and at least two upright mounting members. The at least two upright mounting members extend upward from the support base. A fastener threaded tap or hole is formed through a top of each upright mounting members. The hydraulic pump and the electrical generator are preferably attached to a top surface of the support base. A remote wireless hydraulic cab is attached to the at least two upright mounting members with four fasteners. The hydraulic pump is connected to the hydraulic pressure and return lines. The electrical generator is connected to the electrical bulkhead through the power cable. The remote wireless hydraulic cab may be operated with the docking station.

The remote wireless hydraulic frame preferably includes a frame member, a frame transceiver, a frame bridge controller and an electro-hydraulic conversion valve. The frame member preferably includes a frame support, an engine, a hydraulic pump, at least one electrical component and at least one tool. The engine, the hydraulic pump, the at least one electrical component and the at least one tool are retained on the frame support. The electro-hydraulic conversion valve preferably includes a valve block, a plurality of proportioning valves, at least two shuttle valves and a frame pilot hydraulic circuit. The valve block includes a plurality of proportioning threaded taps for receiving the plurality of proportioning valves, a high side inlet for receiving pressurized hydraulic fluid for the plurality of proportioning valves from the frame pilot hydraulic circuit; a return outlet for return hydraulic fluid from the plurality of proportioning valves to a tank; and a plurality of supply outlets for supplying various hydraulic components with pressurized hydraulic fluid. A supply passage is formed in the valve block to supply the plurality of proportioning valves with hydraulic fluid from the frame pilot circuit. A return passage is formed in the valve block to receive hydraulic fluid from the plurality of proportioning valves. A supply outlet of each proportioning valve supplies hydraulic pressurized hydraulic to a particular hydraulicly operated component. An output pressure of each proportion valve is determined by a hydraulic electrical signal sent from the remote wireless hydraulic cab through the frame bridge controller.

The hydraulic electrical signal originates at a hydraulic control device, such as the joystick or a foot treadle. A control electrical signal originates from an electrical control panel or a display touch screen. The electrical control panel includes a plurality of buttons and knobs. The joystick, foot treadle, electrical control panel and display touch screen are located in the remote wireless hydraulic cab. A hydraulic pressure transmitted from the joystick or foot treadle is converted into a hydraulic electrical signal by the hydraulic pressure sensor. The hydraulic electrical signals and control electrical signals are sent to the cab bridge controller. The plurality of hydraulic electrical signals and control electrical signals are converted into a suitable protocol by the cab bridge controller and sent to the cab transceiver. The cab transceiver wirelessly transmits the hydraulic and control electrical signals to the frame transceiver.

The frame bridge controller receives the hydraulic electrical signals and control electrical signals from the frame transceiver and converts the signals into a suitable form. The hydraulic and control electrical signals are sent from the frame bridge controller to the electro-hydraulic conversion valve, a hydraulic controller, an engine controller and at least one electrical component. The hydraulic electrical signals sent to the electro-hydraulic conversion valve operate the plurality of proportioning valves to control the flow of hydraulic fluid to various hydraulicly operated components. The hydraulic lines from the electro-hydraulic conversion valve preferably include quick coupling ends for retention in a plurality of hydraulic connectors in a hydraulic bulkhead. The hydraulic electrical signals are also sent to the hydraulic controller. The control electrical signals go to the engine controller or the at least one electrical component.

Accordingly, it is an object of the present invention to provide a remote wireless hydraulic frame, which is used in conjunction with a remote wireless hydraulic cab for remote operation of the remote wireless hydraulic frame and the at least one tool.

These and additional objects, advantages, features and benefits of the present invention will become apparent from the following specification.

### BRIEF DESCRIPTION OF THE DRAWINGS

FIG. 1 is a perspective view of a remote wireless hydraulic cab retained on a docking station in accordance with the present invention.

FIG. 2 is a bottom perspective view of a remote wireless hydraulic cab illustrating a plurality of hydraulic lines from a plurality of joysticks and foot treadles connected to a hydraulic sensor plate in accordance with the present invention.

FIG. 3 is a top perspective cutaway view of a remote wireless hydraulic cab illustrating two joysticks and two foot treadles with hydraulic lines connected to a hydraulic sensor plate in accordance with the present invention.

FIG. 4 is a top perspective view of a hydraulic sensor plate of a remote wireless hydraulic cab in accordance with the present invention.

FIG. 5 is an end perspective view of a hydraulic sensor plate of a remote wireless hydraulic cab in accordance with the present invention.

FIG. 6 is a schematic diagram of a remote wireless hydraulic cab illustrating hydraulic and electrical systems in accordance with the present invention.

FIG. 7 is a top view of a remote wireless hydraulic frame in accordance with the present invention.

FIG. 8 is an end perspective view of an electro-hydraulic conversion valve of a remote wireless hydraulic frame in accordance with the present invention.

FIG. 9 is a top perspective view of an electro-hydraulic conversion valve of a remote wireless hydraulic frame in accordance with the present invention.

FIG. 10 is a schematic diagram of an electro-hydraulic conversion valve of a remote wireless hydraulic frame in accordance with the present invention.

### DETAILED DESCRIPTION OF THE PREFERRED EMBODIMENTS

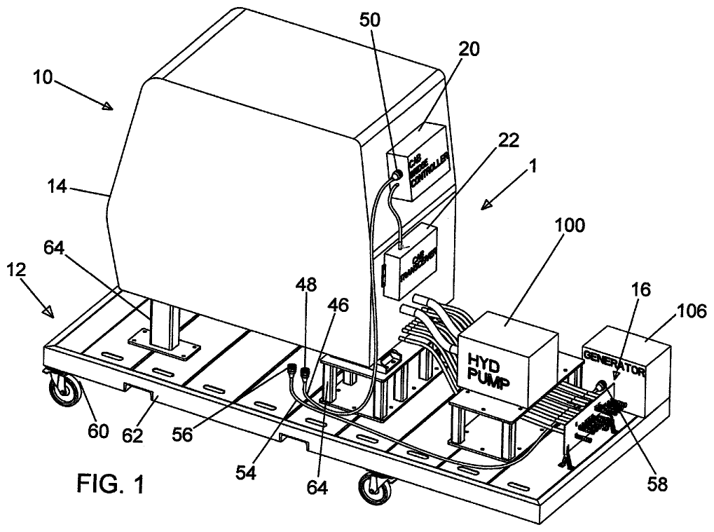

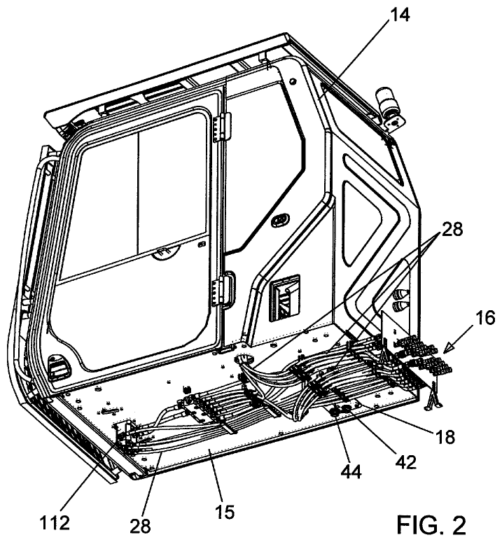

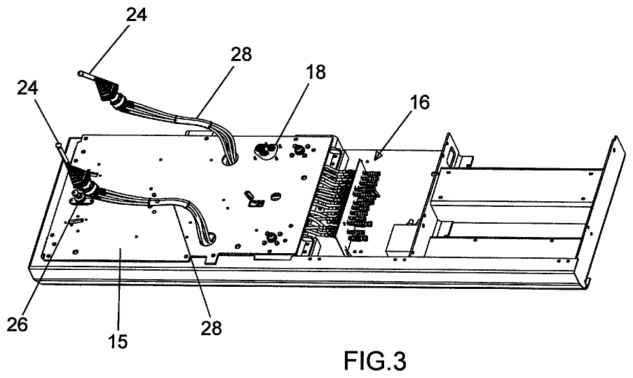

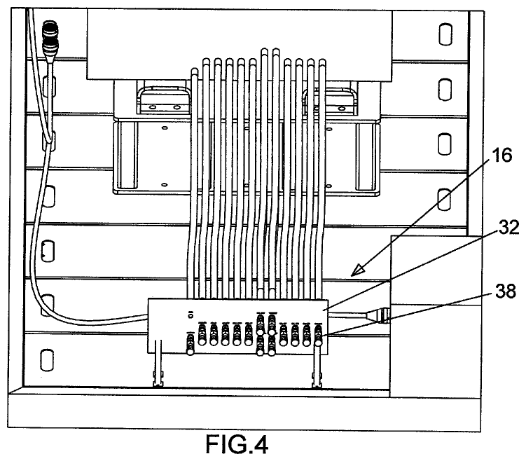

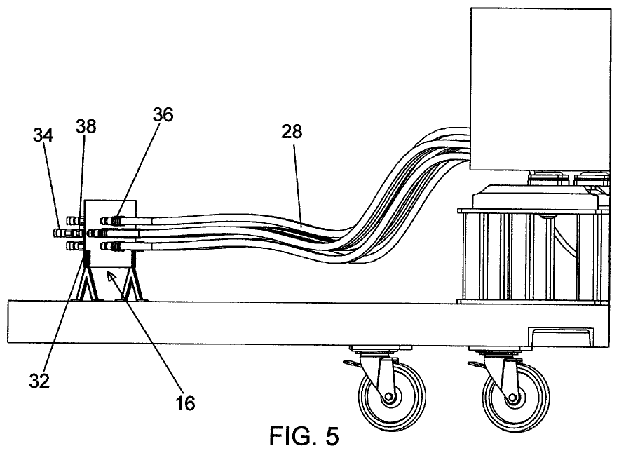

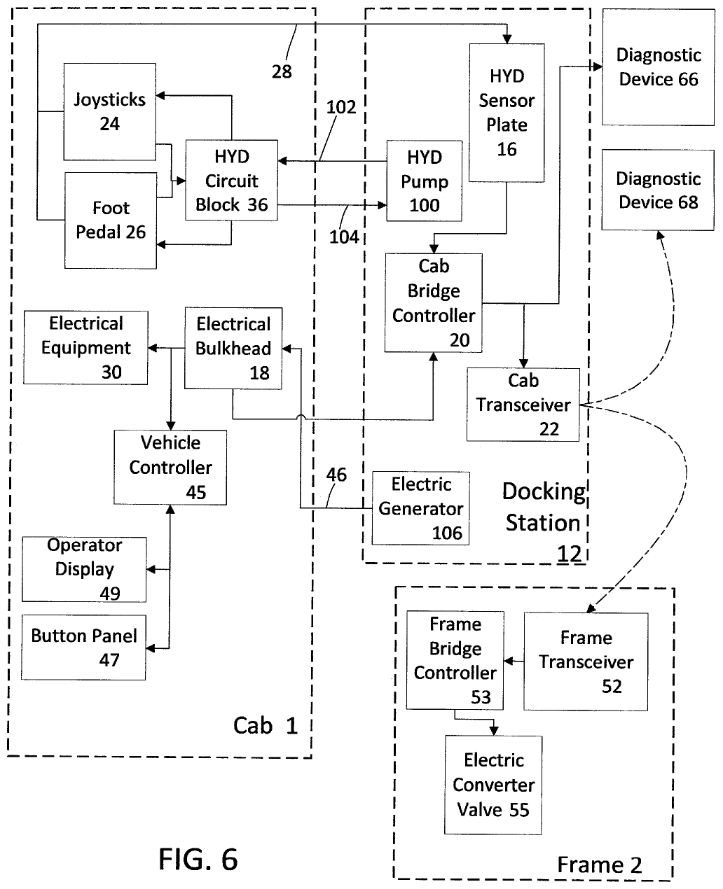

With reference now to the drawings, and particularly to FIG. 1, there is shown a perspective view of a remote wireless hydraulic cab (hydraulic cab) 1 mounted to a docking station 12. With reference to FIG. 6, the hydraulic cab 1 preferably includes a cab member 10, a hydraulic sensor plate 16, an electrical bulkhead 18, a cab bridge controller 20 and a cab transceiver 22. With reference to FIGS. 2-3, the cab member 10 preferably includes a cab enclosure 14, a plurality of hydraulic joysticks 24, a plurality of hydraulic treadles 26, a plurality of hydraulic lines 28 and electrical equipment 30. With reference to FIGS. 4-5, the hydraulic sensor plate 16 includes a plate member 32, a plurality of quick disconnect adapters 36 and a plurality of threaded adapters 38. One end of the plurality of hydraulic lines 28 are connected to the plurality of joysticks 24 and the plurality of hydraulic treadles 26.

A hydraulic pressure line 102 and a hydraulic return line 104 of a hydraulic pump 100 are connected to an input of a hydraulic circuit block 36. The hydraulic pump 100 distributes hydraulic fluid to the plurality of hydraulic joysticks 24 and hydraulic treadles 26 through the hydraulic circuit block 36. The plurality of quick disconnect adapters 36 are threadably engaged with the plate member 32 on one side thereof. The plurality of threaded adapters 38 are threadably engaged with the plurality of quick disconnect adapters 36 on an opposing side of the plate member 32. A plurality of hydraulic pressure sensors 34 are threaded into the plurality of threaded adapters 38. Hydraulic pressure in the joysticks 24 and foot treadles 26 hydraulic lines 28 are measured by the plurality of hydraulic pressure sensors 34. An electrical output from each hydraulic pressure sensor 34 is connected to the cab bridge controller 20. The electrical bulkhead 18 includes a signal socket 42 and a power socket 44. A signal cable 46 includes a bulkhead plug 48 extending from one end and a controller plug 50 extending from an opposing end. The bulkhead plug 48 is plugged into the signal socket 42 and the controller plug 50 is plugged into the cab bridge controller 20 for transfer of electrical signals from the cab member 10 to the cab bridge controller 20. A vehicle controller 45 is preferably used to receive electrical signals from a button panel 47. The vehicle controller 45 is also used to display information to an operator display 49. The operator display 49 also includes a touch screen. The touch screen may be used to send electrical signals from the operator display 49. The vehicle controller 45 is also connected to the cab bridge controller 20 through electrical bulkhead 18.

An output from the cab bridge controller 20 is connected to the cab transceiver 22. The cab bridge controller 20 converts the electrical signals from the plurality of hydraulic sensors 34 and the vehicle controller 45 into a suitable form for wireless transmission. The cab transceiver 22 transmits the plurality of electrical signals from the plurality of hydraulic pressure sensors 34 and electrical signals from the signal socket 42 to a frame transceiver 52. The frame transceiver sends the electrical signals to a frame bridge controller 53, which in turn sends electrical signals, which control hydraulic proportioning valves in an electro-hydraulic conversion valve 55. A power cable 54 includes a generator plug 56 on one end and a power plug 58 on an opposing end. The generator plug 58 is plugged into an electrical generator 106 and the power plug 56 is plugged into the power socket 44. With the hydraulic pump 100 and the electric generator 106 connections, the remote wireless hydraulic cab 1 is capable of operating remotely with a remote wireless hydraulic frame 2 through wireless communication.

The docking station 12 may be used to provide a physical foundation and an operational base for the remote wireless hydraulic cab 1. The docking station 12 includes a base member 60, the hydraulic pump 100 and the electrical generator 106. The base member 60 includes a support base 62 and at least two upright mounting members 64. The at least two upright mounting members 64 extend upward from the support base 62. At least one threaded tap or hole is formed through a top of each upright mounting member 64 to receive a retention bolt inserted through a floor 15 of the cab enclosure 14. The hydraulic sensor plate 16, cab bridge controller 20 and the cab transceiver 22 are preferably retained on the support base 62. The hydraulic pump 100 and the electrical generator 106 are attached to a top surface of the support base 62. With reference to FIG. 6, the hydraulic pump 100 is connected to the hydraulic pressure line 102 and the hydraulic return line 104. The electrical generator 106 is connected to the electrical bulkhead 18 through the power cable 46. The docking station 12 enables the remote wireless hydraulic cab 1 to remotely operate from and wireless with the remote wireless hydraulic frame 2.

However, the remote wireless hydraulic cab 1 does not have to be used with the docking station 12. The hydraulic pump 100 and the electrical generator 106 may be connected to the remote wireless hydraulic cab 1 from any other suitable source, besides the docking station 12. The hydraulic sensor plate 16, the cab bridge controller 20 and the cab transceiver 22 would be physically retained on the remote wireless hydraulic cab 1 and not on the docking device 12.

A diagnostic device 66 may be connected to the cab bridge controller 20 through a wired connection to monitor hydraulic pressures of the joysticks 24 and foot treadles 26, and status of the buttons of the button panel 47. A diagnostic device 68 may be connected to the cab bridge controller 20 through a wireless connection.

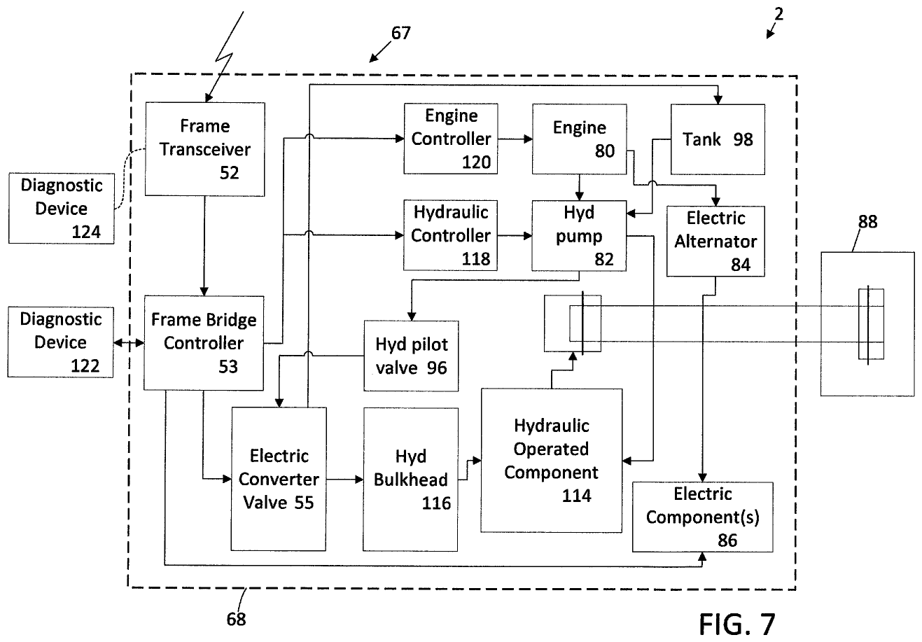

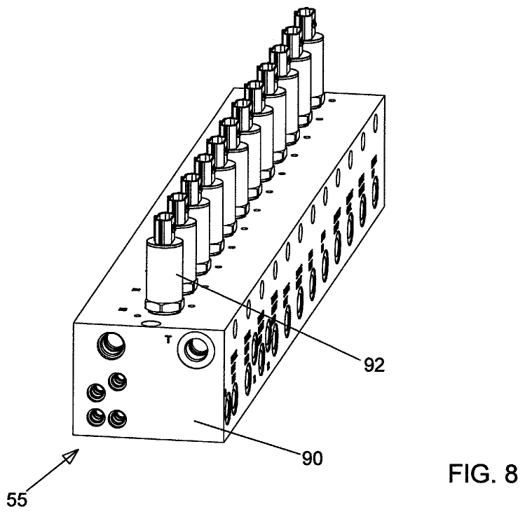

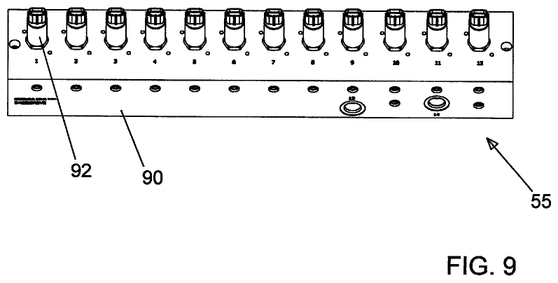

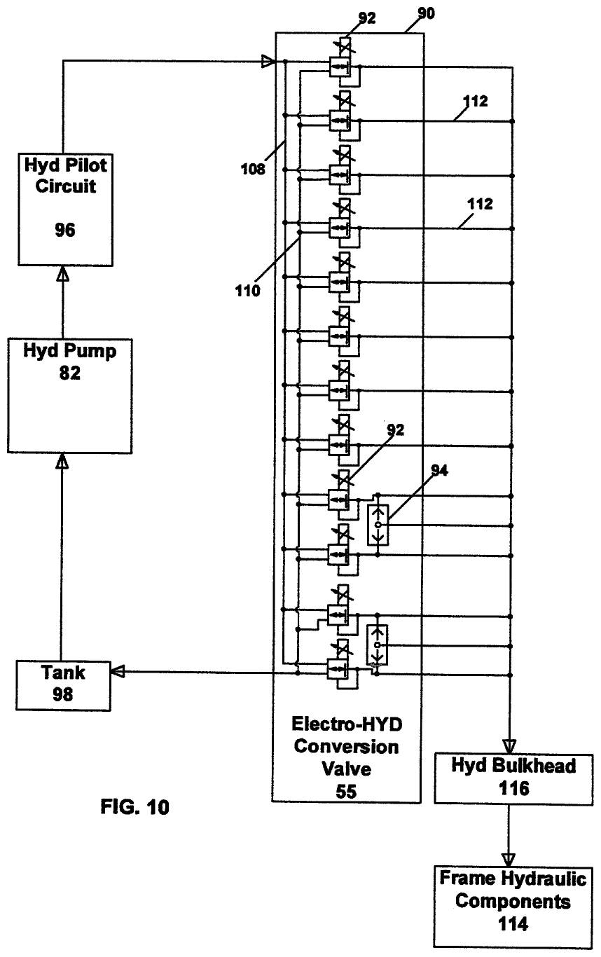

With reference to FIG. 7, the remote wireless hydraulic frame 2 preferably includes a frame member 67, a frame transceiver 52, a frame bridge controller 53 and an electro-hydraulic conversion valve 55. The frame member 67 preferably includes a frame support 68, an engine 80, a hydraulic pump 82, an electrical alternator 84, at least one electrical component 86 and at least one tool 88. The engine 80, the hydraulic pump 82, the electrical alternator 84, the at least one electrical component 86 and the at least one tool 88 are retained on the frame support 68. The electrical alternator 84 is driven by the engine 80. With reference to FIGS. 8-10, the electro-hydraulic conversion valve 55 preferably includes a valve block 90, a plurality of proportioning valves 92, at least two shuttle valves 94 and a frame pilot hydraulic circuit 96. The valve block 90 includes a plurality of proportioning threaded taps for receiving the plurality of proportioning valves 92; a high side inlet for receiving pressurized hydraulic fluid for the plurality of proportioning valves 92 from the frame pilot hydraulic circuit 96; a return outlet for returning hydraulic fluid from the plurality of proportioning valves 92 to a tank 98 and a plurality of supply outlets for supplying various hydraulic components with pressurized hydraulic fluid. The shuttle valves 94 send an electrical signal to an alarm device, when the remote wireless hydraulic frame 2 is moving.

A supply passage 108 is formed in the valve block 90 to supply the plurality of proportioning valves 92 with hydraulic fluid from the frame pilot circuit 96. A return passage 110 is formed in the valve block 90 to receive hydraulic fluid from the plurality of proportioning valves 92. A supply outlet 112 of each proportioning valve 92 supplies hydraulic pressurized hydraulic to a particular hydraulicly operated component 114 preferably through a hydraulic bulkhead 116. An output pressure of each proportion valve 92 is determined by a hydraulic electrical signal sent from the frame bridge controller 53. The hydraulic electrical signal originates at a hydraulic control device, such as the hydraulic joystick 24 or the hydraulic foot treadle 26. A control electrical signal originates from an electrical control panel 47 or an operator display 49. The electrical control panel 47 includes a plurality of buttons and knobs. The operator display 49 includes a touch screen. The joystick, foot treadle, electrical control panel and touch screen are located in the hydraulic remote cab 1. A hydraulic pressure transmitted from the joystick 24 or foot treadle 26 is converted into the hydraulic electrical signal by the hydraulic pressure sensor 34. The hydraulic electrical signals and control electrical signals are sent to the cab bridge controller 20. The plurality of hydraulic electrical signals and control electrical signals are converted into a suitable protocol by the cab bridge controller 20 and sent to the cab transceiver 22. The cab transceiver 22 wirelessly transmits the hydraulic and control electrical signals to the frame transceiver 52.

The frame bridge controller 53 receives the hydraulic and control electrical signals from the frame transceiver 52 and converts the signals into a suitable form. The hydraulic and control electrical signals are sent from the frame bridge controller 53 to the electro-hydraulic conversion valve 55, a hydraulic controller, an engine controller and the at least one electrical component 86. The hydraulic electrical signals sent to the electro-hydraulic conversion valve 55 operate the plurality of proportioning valves 92 to control the flow of hydraulic fluid to various hydraulicly operated components 114. However, a remote wireless electrical cab could be used with the remote hydraulic frame. The remote wireless electrical cab would have electrical joysticks and foot treadles, instead of hydraulic joysticks and foot treadles. The hydraulic controller 118 would be used to operate the hydraulic operated components 114 and the at least one tool 88 instead of the electro-hydraulic conversion valve 55. Outlet hydraulic lines 112 from the electro-hydraulic conversion valve 55 preferably include quick coupling ends for retention in a plurality of hydraulic connectors in the hydraulic bulkhead 116. The hydraulic electrical signals are also sent to the hydraulic controller 118. The control electrical signals go to the engine controller or the at least one electrical component 86.

A diagnostic device 122 may be connected to the frame bridge controller 53 through a wired connection to monitor various hydraulic pressures of the frame operated components 114 and status of the hydraulic controller 118, the engine controller 120, and electrical components 86. A wireless diagnostic device 124 may be connected to the cab bridge controller 20 through a wireless connection.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

We claim:

1. A remote wireless hydraulic frame for communication with a remote wireless hydraulic cab, the remote wireless hydraulic cab includes at least one hydraulic control device, an output from the at least one hydraulic control device is converted into at least one hydraulic electrical signal, the at least one hydraulic electrical signal is wirelessly transmitted to the remote wireless hydraulic frame, comprising:
a frame member;
a frame transceiver receives the at least one wireless hydraulic electrical signal from the remote wireless cab;
a frame bridge controller receives the at least one wireless hydraulic electrical signal from said frame transceiver; and
an electro-hydraulic conversion valve includes a plurality of proportioning valves, pressurized fluid is supplied to said plurality of proportioning valves, a return passage is connected to said plurality of proportioning valves, a plurality of supply outlets are connected to said plurality of proportioning valves, wherein said plurality of supply outlets are connected to a plurality of hydraulic components on the frame member, said frame bridge controller outputs at least one hydraulic electrical signal to said plurality of proportioning valves.

2. The remote wireless hydraulic frame of claim 1, further comprising:
a hydraulic bulkhead includes a plurality of quick coupling ends for retention of a plurality of outlet lines which extend from said plurality of supply outlets.

3. The remote wireless hydraulic frame of claim 1, further comprising:
a wireless diagnostic device communicates with said frame transceiver.

4. The remote wireless hydraulic frame of claim 1, further comprising:
a diagnostic device is connected to said frame bridge controller.

5. A remote wireless hydraulic frame for communication with a remote wireless hydraulic cab, the remote wireless hydraulic cab includes at least one hydraulic control device, an output from the at least one hydraulic control device is converted into at least one hydraulic electrical signal, the at least one hydraulic electrical signal is wirelessly transmitted to the remote wireless hydraulic frame, comprising:
a frame member;
a frame transceiver receives the at least one wireless hydraulic electrical signal from the remote wireless cab;
a frame bridge controller receives the at least one wireless hydraulic electrical signal from said frame transceiver; and
an electro-hydraulic conversion valve includes a valve block and a plurality of proportioning valves, a plurality of threaded taps are formed in the valve block to receive the plurality of proportioning valves, pressurized fluid is supplied to said plurality of proportioning valves through a pressurized pathway in said valve block, a return passage is formed in said valve block and connected to said plurality of proportioning valves, a plurality of supply outlets are connected to said plurality of proportioning valves through said valve block, wherein said supply outlets are connected to a plurality of hydraulic components on the frame member, said frame bridge controller outputs at least one hydraulic electrical signal to said plurality of proportioning valves.

6. The remote wireless hydraulic frame of claim 5, further comprising:
a hydraulic bulkhead includes a plurality of quick coupling ends for retention of a plurality of outlet lines which extend from said plurality of supply outlets.

7. The remote wireless hydraulic frame of claim 5, further comprising:
a wireless diagnostic device communicates with said frame transceiver.

8. The remote wireless hydraulic frame of claim 5, further comprising:
a diagnostic device is connected to said frame bridge controller.

9. A remote wireless hydraulic frame for communication with a remote wireless hydraulic cab, the remote wireless cab includes at least one hydraulic control device and at least one electrical control device, an output from the at least one hydraulic control device is converted into at least one hydraulic electrical signal, the at least one hydraulic electrical signal and the at least one control electrical signal are wirelessly transmitted to the remote wireless hydraulic frame, comprising:
a frame member;
a frame transceiver receives the at least one wireless hydraulic electrical signal and the at least one wireless control electrical signal from the remote wireless cab;
a frame bridge controller receives the at least one wireless hydraulic electrical signal and the at least one wireless control electrical signal from said frame transceiver; and
an electro-hydraulic conversion valve includes a plurality of proportioning valves, pressurized fluid is supplied to said plurality of proportioning valves, a return passage is connected to said plurality of proportioning valves, a plurality of supply outlets are connected to said plurality of proportioning valves, wherein said supply outlets are connected to a plurality of hydraulic components on the frame member, said frame bridge controller outputs at least one hydraulic electrical signal to said plurality of proportioning valves, said frame bridge controller outputs at least one control electrical signal to at least one electrical component.

10. The remote wireless hydraulic frame of claim 9, further comprising:
a hydraulic bulkhead includes a plurality of quick coupling ends for retention of a plurality of outlet lines which extend from said plurality of supply outlets.

11. The remote wireless hydraulic frame of claim 9, further comprising:
a wireless diagnostic device communicates with said frame transceiver.

12. The remote wireless hydraulic frame of claim 9, further comprising:
a diagnostic device is connected to said frame bridge controller.
